(19) United States
(12) Patent Application Publication
(10) Pub. No.: US 2024/0376962 A1
(43) Pub. Date: Nov. 14, 2024

(54) GEARBOX SYSTEM WITH BALANCE BEAM AND OPERATING METHOD

(71) Applicant: Dana Automotive Systems Group, LLC, Maumee, OH (US)

(72) Inventor: Burke SMITH, Bruce Township, MI (US)

(21) Appl. No.: 18/637,861

(22) Filed: Apr. 17, 2024

Related U.S. Application Data
(60) Provisional application No. 63/501,557, filed on May 11, 2023.

(51) Int. Cl. F16H 1/20; B60K 17/04; F16H 1/24; F16H 57/02; F16H 57/021

(52) U.S. Cl. CPC F16H 1/20; B60K 17/04; F16H 1/24; F16H 57/021; F16H 2057/02034; F16H 2057/02043

(57) ABSTRACT

Systems and methods for a gearbox. The gearbox system, in one example, includes an input shaft with a first helical gear coupled thereto, a first intermediate shaft with a second helical gear coupled thereto and meshing with the first helical gear and a second intermediate shaft with a third helical gear coupled thereto and meshing with the first helical gear. The gearbox system further includes a balance beam that transfers loads between the first intermediate shaft and the second intermediate shaft.

### CROSS REFERENCE TO RELATED APPLICATION

The present application claims priority to U.S. Provisional Application No. 63/501,557, entitled “GEARBOX SYSTEM WITH BALANCE BEAM AND OPERATING METHOD”, and filed on May 11, 2023. The entire contents of the above-listed application are hereby incorporated by reference for all purposes.

### TECHNICAL FIELD

The present disclosure relates to a gearbox system with a balance beam coupled to countershafts.

### BACKGROUND AND SUMMARY

Gearboxes are used in powertrains, and other systems, for speed changes in relation to the input and the output of the gearbox. For instance, certain gearboxes are used in electric vehicle (EV) and internal combustion engine powertrains to provide a desired speed reduction for the axle assembly in the drivetrain.

Certain vehicle platforms may have high torque and compact packaging demands for the gearboxes. For instance, certain electric axle platforms have high torque and space efficiency targets. US 2022/0196126 A1 to Downs et al. discloses an electric drive module with a transmission. The transmission includes parallel pairs of gears that share loads and mesh with a final drive gear in an attempt to manage high demand loads (e.g., due to face width, packaging, and/or other constraints). The transmission disclosed by Downs specifically creates parallel power paths in an attempt to decrease component load.

However, the inventors have recognized that in Downs' transmission and other gearboxes with parallel load paths, one of the load paths may take the bulk of the load due factors such as manufacturing tolerance stack up. As such, the components in this load path may experience accelerated degradation. As a result, the longevity of the transmission is reduced and load is less evenly distributed amongst transmission components.

The inventors have recognized the abovementioned challenges and developed a gearbox system to at least partially overcome the challenges. The gearbox system includes, in one example, an input shaft with a first helical gear coupled thereto. The gearbox system further includes a first intermediate shaft with a second helical gear coupled thereto and meshing with the first helical gear. Additionally, the gearbox system includes a second intermediate shaft with a third helical gear coupled thereto and meshing with the first helical gear. The gearbox system further includes a balance beam that transfers loads between the first intermediate shaft and the second intermediate shaft. In the system, the second helical gear and the third helical gear are identically sized. In this way, the balance beam functions to balance loads between the intermediate shafts, thereby decreasing gearbox component wear and increasing gearbox longevity.

In one example, the gearbox system may further include a first axial thrust bearing coupled to a first end of the balance beam and the first intermediate shaft and a second axial thrust bearing coupled to a second end of the balance beam and the second intermediate shaft. Further, in such an example, the system may even further include a fulcrum coupled to the balance beam. In this way, thrust loads from the intermediate shafts are effectively transferred to the balance beam, enabling the load balancing functionality to be space efficiently achieved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of a vehicle with a powertrain that includes a gearbox.

FIG. 2 shows a first example of a gearbox system with a balance beam.

FIG. 3 shows a mechanical power path through the gearbox system while the gearbox is in operation, depicted in FIG. 2.

### DETAILED DESCRIPTION

A gearbox assembly with parallel power paths and load balancing functionality between the power paths is described herein which increases gearbox longevity by diminishing undesirable localized imbalanced component loading. To accomplish the load balancing functionality, the gearbox system includes a balance beam assembly that balances loads between parallel countershafts which are generated by similarly sized helical gears that are fixedly coupled to the countershafts. To elaborate, the balance beam may be coupled to axial thrust bearings which are attached to the countershafts. The balance beam may further be grounded by a fulcrum that is pivotally attached to a mid-portion of the beam, to allow the balance beam to effectively balance loads between the countershafts, and decrease component wear as a consequence.

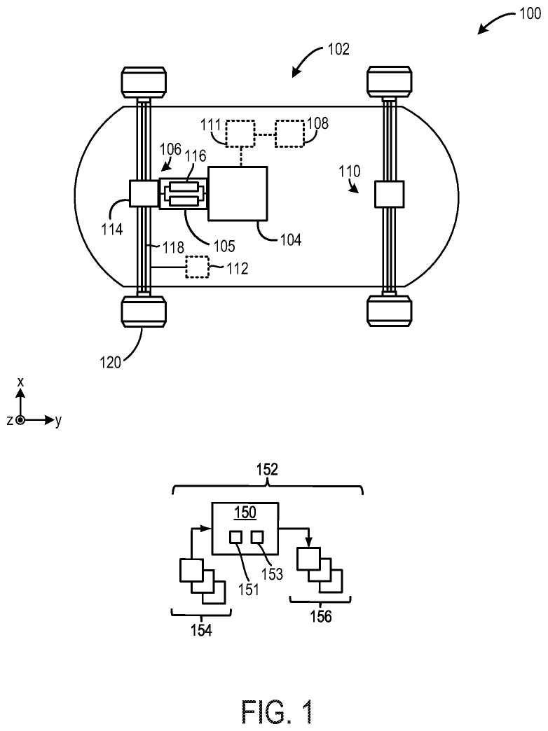

FIG. 1 shows a schematic illustration of a vehicle 100 with a powertrain 102. The powertrain 102 may include a prime mover 104 (e.g., a traction motor and/or an internal combustion engine), a gearbox 105, and an axle assembly 106. As such, the vehicle may be an electric vehicle (EV) such as an all-electric vehicle or a hybrid electric vehicle (HEV), in some examples. In the HEV example, the engine may function to recharge an energy storage device 108 (e.g., one or more traction batteries, capacitors, fuel cells, combinations thereof, and the like) which may be included in the powertrain or may provide mechanical power to another drive axle. However, in another example, the internal combustion engine (ICE) may be used to provide propulsive power to the axle assembly 106 and/or another axle assembly 110. In such an example, the powertrain may be referred to as an ICE powertrain.

In the EV example, the traction motor may be a motor-generator which therefore may be used to recharge the energy storage device 108 during certain operating conditions, in one example. Further, in the EV example, the traction motor may be an alternating current (AC) motor (e.g., a multiphase motor) which may be more efficient than other types of motors. In such an example, an inverter 111 is electrically coupled to the energy storage device 108 and the traction motor. The inverter 111 is configured to convert AC to direct current (DC) and vice versa. However, in other examples, a DC type traction motor may be used in the EV powertrain.

Further, in the EV example, the vehicle includes an electric drive which may be in the form of an electric drive axle, in one specific example. In such an example, the traction motor and the gearbox 105 are incorporated into the axle assembly 106. However, in other examples, the gearbox and/or traction motor may be spaced away from the axle assembly 106.

The electric drive axle may be an electric beam axle, in one example, which may be more durable and can carry higher loads than drive axles which are coupled to independent suspension systems. Therefore, in such an example, the gearbox 105, the differential 114, the prime mover 104 which is embodied as a traction motor in this example, and in some cases the inverter 111 may be incorporated into an integrated unit that forms the electric drive axle. To elaborate, the inverter, the traction motor, the gearbox, and a differential (which is discussed in greater detail herein) may be collocated into a structurally continuous unit, in the electric drive axle example.

A beam axle is an axle with mechanical components which structurally support one another and extend between drive wheels. For instance, the beam axle may be a structurally continuous structure that spans the drive wheels on a lateral axis, in one embodiment. Thus, wheels coupled to the beam axle substantially move in unison when articulating, during, for example, vehicle travel on uneven surfaces. To elaborate, in the beam axle example, the camber angle of the wheels may remain substantially constant as the suspension moves through its travel. Therefore, the beam axle may be coupled to a dependent suspension system 112, in one example. However, in other examples, the electric axle may not be a beam axle and the axle may be coupled to an independent suspension system. Electric axles are able to be more easily incorporated into a variety of vehicle platforms when compared to electric drive units with the traction motor and gearbox spaced away from the axle. Consequently, the powertrain's customer appeal is expanded.

In the illustrated example, the gearbox 105 delivers mechanical power to a differential 114 of the axle assembly 106. However, it will be appreciated that the gearbox 105 may additionally or alternatively deliver mechanical power to the axle assembly 110. Still further, in other examples, the gearbox may be incorporated into one of the axles to form an electric axle assembly, as previously indicated.

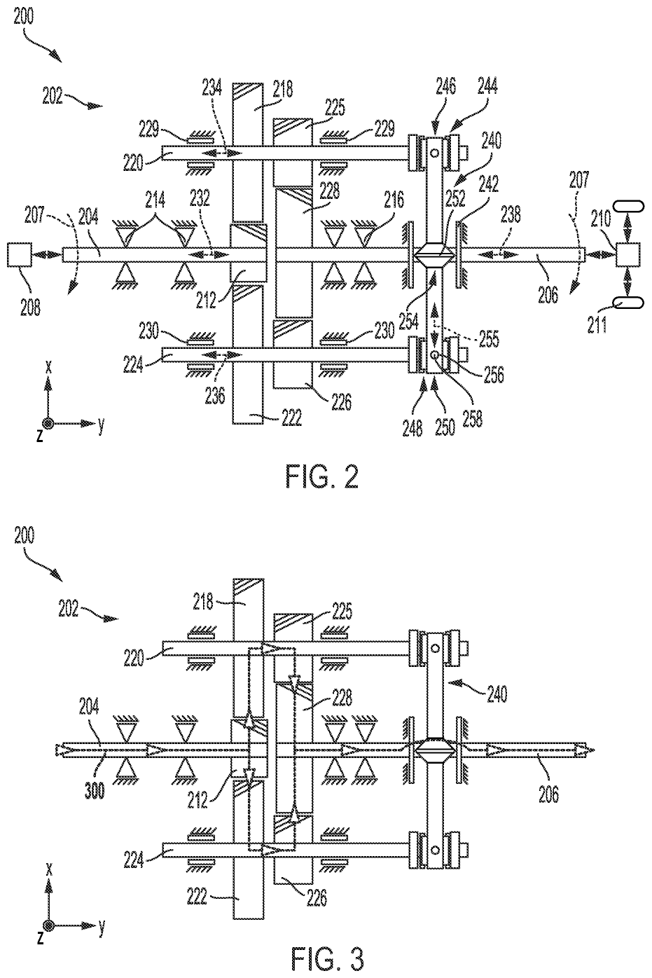

The gearbox 105 may be configured to receive torque from the prime mover 104 via a shaft (e.g., a drive shaft) and/or other suitable mechanical component, for instance. The gearbox 105 is configured with parallel mechanical branches 116 that include countershafts and gears. The architecture of the parallel power paths in the gearbox is expanded upon herein with regard to FIGS. 2-3. More generally, the gearbox 105 and the mechanical branches 116 are schematically depicted in FIG. 1. However, it will be appreciated that the gearbox has greater structural and functional complexity.

Further, as shown in FIG. 1, the gearbox 105 may output torque to the differential 114. Torque from the gearbox 105 may drive rotation of the differential 114, which may in turn drive rotation of axle shafts 118 which are rotationally coupled to drive wheels 120.

A controller 150 may form a portion of a control system 152. The controller 150 includes a processor 151 and memory 153. The control system 152 is shown receiving information from sensors 154 and sending control signals to actuators 156. As one example, the sensors 154 may include sensors such as an energy storage device state of charge sensor, wheel speed sensors, gearbox speed sensors, an inverter current sensor, and the like. As another example, the actuators may include an actuator in the inverter for the traction motor. The controller 150 may receive input data from the sensors, process the input data via a processor, and trigger the actuators in response to the processed input data based on instruction or code programmed therein corresponding to one or more routines. In some examples, the controller 150 may include instructions that send a command signal to the inverter 111 to adjust the output speed of the prime mover 104 (e.g., traction motor).

An axis system is provided in FIG. 1 as well as FIGS. 2-3, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

FIG. 2 shows an example of a gearbox system 200 with a gearbox 202. The gearbox 202 is an example of the gearbox 105 depicted in FIG. 1. As such, at least a portion of the structural and/or functional features from the gearbox 202 may be included in the gearbox 105 and vice versa. Further, the gearbox 202 may be included in the powertrain 102, shown in FIG. 1, or another suitable powertrain.

The gearbox 202 includes an input shaft 204 and an output shaft 206. Arrows 207 denote exemplary rotational directions of the input and output shafts during operation. However, it will be understood that the rotational directions may be reversed, in other examples. The input shaft 204 is configured to attach to an upstream component 208 (e.g., a prime mover such as a traction motor and/or an ICE) and the output shaft 206 is configured to attach to a downstream component 210 (e.g., a differential). To achieve this mechanical attachment splines, shafts, gears, chains, combinations thereof, and the like may be used in the powertrain. In turn, the differential 210 is configured to rotationally couple to drive wheels 211. The rotational axes of the drive wheels are parallel to the x-axis, in the illustrated example. However, the drive wheels may have other orientations, in alternate examples. Still further, in other examples, the downstream component may include shafts, joints, combinations thereof, which deliver mechanical power to one or more differentials which are spaced away from the gearbox 202.

In one example, the input shaft 204 may be coupled to a prime mover with its rotational axis position coaxial thereto. In alternate examples, the rotational axis may be offset (e.g., parallel to the rotational axis of the input shaft. Still further, in other examples, the prime mover's rotational axis may be angled (e.g., arranged perpendicular) with regard to the input shaft's rotational axis. The arrangement of the prime mover may be selected based on end-use packaging demands.

As discussed herein, input and output denotes the direction of mechanical power flow in a drive configuration (e.g., a forward drive direction where the prime mover is spun in a first direction or a reverse drive direction where the prime mover is spun in the opposite direction). However, it will be appreciated that when the prime mover is a traction motor the motor may be operated in a regeneration mode where mechanical power travels in a reverse direction through the gearbox from the downstream component 210 to the upstream component 208. Further, gearbox may include a mechanical reverse assembly, in one example. However, as indicated above, when the powertrain includes a traction motor the motor may be spun in a reverse direction.

A helical gear 212 (e.g., a helical pinion gear) is coupled to the input shaft 204 such that the helical gear and the input shaft rotate in unison. For instance, the helical gear 212 may be welded, bolted, splined, combinations thereof, and the like to the input shaft 204. Further, in other examples, the helical gear 212 may be machined on the input shaft 204. The other gears described herein that are coupled to other shafts such that they rotate in unison may be coupled to one another using any of the aforementioned techniques. The helical gear 212 is specifically illustrated as a right hand helical gear. However, it will be understood that the helical gear 212 may be a left hand helical gear, in other examples. More generally, the gears described herein include teeth and coupling between the gears denotes meshing of the teeth such that torque transfer between the gears occurs.

In the illustrated example, axial and radial load bearings 214 are coupled to the input shaft 204 such that they react axial and radial loads of the input shaft 204 during gearbox operation. Likewise, in the illustrated example, axial and radial load bearings 216 are coupled to the output shaft 206 such that they react axial and radial loads of the output shaft during gearbox operation. However, other bearings layouts for the input shaft 204 and/or the output shaft 206 have been contemplated. For instance, separate radial bearings and thrust bearings may be coupled to each of the input shaft and/or the output shaft. As described herein, a bearing may include races (e.g., an outer race and an inner race) and roller elements (e.g., spherical balls, cylindrical rollers, tapered cylindrical rollers, and the like).

A helical gear 218 is coupled to an intermediate shaft 220 such that it rotates therewith during gearbox operation. Likewise, a helical gear 222 is coupled to an intermediate shaft 224 such that it rotates therewith. The helical gears 218, 222 may specifically be left hand helical gears. Further, the helical gear 218 and the helical gear 222 are identically sized and each mesh with the helical gear 212. To elaborate, each of the helical gears 218, 222 may be identical in profile (e.g., tooth size, tooth geometry, gear diameter, and the like). The intermediate shafts described herein may specifically be countershafts.

Additionally, a helical gear 225 is coupled to the intermediate shaft 220 such that is rotates therewith and a helical gear 226 is coupled to the intermediate shaft 224 such that is rotates therewith. The helical gears 225, 226 may specifically be left handed pinion gears (e.g., final drive pinion gears). However, the helical gears 225, 226 may take other suitable forms, in other examples. Further, the helical gear 225 and the helical gear 226 are identically sized and each mesh with a helical gear 228 (e.g., a final drive helical gear) that is coupled to the output shaft 206 such that is rotates therewith. To elaborate, each of the helical gears 225, 226 may be identical in profile (e.g., tooth size, tooth geometry, gear diameter, and the like).

Radial bearings 229, 230 may be coupled to each of the intermediate shafts 220, 224. To elaborate, the radial bearings 229 may be positioned axially outboard of the helical gears 218 and 224 on the intermediate shaft 220. Likewise, the radial bearings 230 may be positioned axially outboard of the helical gears 222 and 226 on the intermediate shaft 224. In this way, the intermediate shafts may be radially supported in a more balanced manner which is expanded upon below, thereby decreasing uneven loading in the system. However, other bearing configurations have been envisioned. For instance, a single radial bearing may be coupled to each of the intermediate shafts or more than two radial bearings may be coupled to each of the intermediate shafts. Using radial bearings for the intermediate shafts allows thrust loads to be transferred through a balance beam assembly which functions to more evenly distribute loads in the gearbox and is expanded upon herein.

The intermediate shafts 220, 224 are parallel to one another, in the illustrated example. However, in other examples, the intermediate shafts 220, 224 may have a symmetric orientation with regard to the rotational axes of the input shaft 204 and the output shaft 206. Rotational axes 232, 234, 236, 238 of the input shaft 204, the intermediate shaft 220, the intermediate shaft 224, and the output shaft 206 is provided for reference.

A balance beam 240 is coupled to the intermediate shafts 220, 224 such that is balances loads between the intermediate shafts 220, 224. To elaborate, the balance beam 240 is configured to simultaneously react the axial loads of two intermediate shafts 220, 224 and “balances” these loads against a stationary component 242 (e.g., the gearbox housing, the e-axle housing, and the like). The balance beam 240 may be in the form of a hollow shaft, a solid shaft, and the like, which may have a variety of shapes in radial cross-section (e.g., a polygonal shape, a circular or oval shape, and the like). The profile of the balance beam may be selected based on the magnitude and location of the expected loading on the beam.

The balance beam 240, in the illustrated example, is coupled to an axial thrust bearing 244 at a first end 246 and an axial thrust bearing 248 at another end 250. The axial thrust bearings 244, 248 are coupled to the intermediate shafts 220, 224 such that they react axial loads from the shafts. In this way, loads are more evenly distributed in the gearbox. However, the balance beam 240 may be coupled to the intermediate shafts 220, 224, in another suitable manner, in alternate examples.

Further, in the illustrated example, the gearbox 202 includes a fulcrum 252 coupled to the balance beam 240 at a mid-portion 254. As such, the balance beam 240 pivots about the fulcrum 252 to balance the net axial force on the intermediate shafts 220, 224. The fulcrum 252 is grounded by the stationary component 242 (e.g., the gearbox housing), in the illustrated example. However, other kinematic architectures of the balance beam may be used, in other examples.

The balance beam 240 may be allowed to slightly rotate about an axis 255 and slightly translate along the axis 255 which may be perpendicular to the intermediate shafts 220, 224. To accomplish this constrained rotational and translation movement of the balance beam, the beam may include slots 256 at each end that mate with extensions 258 in the thrust bearings 244, 248 to allow for the desired rotation and translation of the balance beam. As such, the slots and extension may have gaps when mated, to allow for this desired beam motion.

The range of translation of the intermediate shafts 220, 224 and therefore the angular rotation of the balance beam may scale with the size of the system which may be dictated based on end-use design targets. Using the balance beam with the features describe herein allows the balance beam to work with comparatively large translation ranges of the intermediate shafts (e.g., 10 millimeters and a 5° angular rotation of the balance beam, in one specific use-case example) to account for gears and surrounding components manufactured with high tolerances, if desired. In another example, to constrain dynamic motion and gear backlash, the range of translation of the intermediate shafts may be decreased (e.g., 0.2 mm and a minute of a degree of angular rotation of the balance beam, in one use-case example).

During gearbox operation, the helical gears 218, 222, 224, 226 on the intermediate shafts 220, 224 will produce axial forces which will be opposite directions, but it is expected that by design the net force will still be significant enough to balance the loads.

It will be understood, that the gearbox 202 shown in FIG. 2 is able to more evenly balance loads when the powertrain is operated in a drive mode as well as a coast mode and a regeneration mode, in the EV powertrain example. In other words, the gearbox 202 is able to balance load when rotated in both clockwise and counterclockwise directions.

FIG. 3 shows a mechanical power path 300 that occurs in the gearbox system 200 during drive mode operation (e.g., forward or reverse drive mode operation). The mechanical power path 300 unfolds as follows: mechanical power travels from the upstream component to the input shaft 204, from the input shaft 204 to the helical gears 218 and 222 via the helical gear 212, from the helical gears 218 and 222 to the intermediate shafts 220 and 224, respectively, from the intermediate shafts 220 and 224 to the helical gears 225 and 226, from the helical gears 225 and 226 to the helical gear 228, from the helical gear 228 to the output shaft 206, and from the output shaft 206 to the downstream component. As the power path 300 occurs, loads are transferred through the balance beam 240 to more evenly equalize the loads in the system. In this way, the gearbox 202 exhibits a parallel power path which more evenly distributes loads and increases component longevity.

The gearbox with the balance beam assembly described herein is efficient to manufacture and less sensitive to lower manufacturing tolerance than previous parallel path gearboxes. Consequently, complex and costly manufacturing processes, special assembly procedures, and the like of the gearbox component may be avoided, if desired. The gearbox may be more efficiently manufactured as a result.

The descriptions of FIGS. 1-3 herein provide for a gearbox operating method that includes balancing loads between a first intermediate shaft and a second intermediate shaft via a balance beam that is coupled to the first intermediate shaft and the second intermediate shaft via a first axial thrust bearing and a second axial thrust bearing. The method may further include transferring mechanical power from a prime mover (e.g., a traction motor) to the input shaft. It will be appreciated that the aforementioned method steps may passively occur as a result of torque transfer from the prime mover to the gearbox or from the drive axle to the gearbox.

The technical effect of the methods for gearbox operation described herein is to more evenly distribute loads on the intermediate shafts to increase gearbox component longevity. Consequently, the gearbox is less susceptible to degradation, thereby increasing gearbox reliability. Further, gearbox manufacturing may also be simplified, if desired.

FIGS. 1-3 show example configurations with relative positioning of the various components. It will be appreciated that if elements are shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Still further in some examples, elements positioned coaxial or parallel to one another may be referred to as such.

The invention will be further described in the following paragraphs. In one aspect, a gearbox system is provided that comprises an input shaft with a first helical gear coupled thereto; a first intermediate shaft with a second helical gear coupled thereto and meshing with the first helical gear; a second intermediate shaft with a third helical gear coupled thereto and meshing with the first helical gear; and a balance beam that transfers loads between the first intermediate shaft and the second intermediate shaft; wherein the second helical gear and the third helical gear are identically sized.

In another aspect, a method for operation of a gearbox system is provided that comprises balancing loads between a first intermediate shaft and a second intermediate shaft via a balance beam coupled to the first intermediate shaft and the second intermediate shaft via a first axial thrust bearing and a second axial thrust bearing; wherein the gearbox system includes: an input shaft with a first helical gear coupled thereto; a second helical gear coupled to the first intermediate shaft and meshing with the first helical gear; a third helical gear coupled to the second intermediate and meshing with the first helical gear. Further, in one example, the method may include transferring mechanical power from a prime mover to the input shaft.

In yet another aspect, a gearbox system is provided that comprises an input shaft with a first helical gear coupled thereto; a first intermediate shaft with a second helical gear coupled thereto and meshing with the first helical gear; a second intermediate shaft with a third helical gear coupled thereto and meshing with the first helical gear; and a balance beam coupled to the first intermediate shaft and the second intermediate shaft via a first axial thrust bearing and a second axial thrust bearing; wherein the second helical gear and the third helical gear are identically sized; and wherein the first intermediate shaft and the second intermediate shaft are parallel to one another.

In any of the aspects or combinations of the aspects, the gearbox system may further comprise a first axial thrust bearing coupled to a first end of the balance beam and the first intermediate shaft; and a second axial thrust bearing coupled to a second end of the balance beam and the second intermediate shaft.

In any of the aspects or combinations of the aspects, the gearbox system may further comprise a fulcrum coupled to the balance beam.

In any of the aspects or combinations of the aspects, the fulcrum may be grounded by a gearbox housing.

In any of the aspects or combinations of the aspects, the first end of the balance beam may be coupled to the first axial thrust bearing via a first slotted interface and the second end of the balance beam may be coupled to the second axial thrust bearing via a second slotted interface.

In any of the aspects or combinations of the aspects, the gearbox system may further comprise a first radial bearing coupled to the first intermediate shaft and a second radial bearing coupled to the second intermediate shaft.

In any of the aspects or combinations of the aspects, the gearbox system may further comprise an output shaft with a fourth helical gear coupled thereto; a fifth helical gear coupled to the first intermediate shaft; and a sixth helical gear coupled to the second intermediate shaft; wherein the fifth helical gear and the sixth helical gear are identical in size.

In any of the aspects or combinations of the aspects, the gearbox system may further comprise a first radial and axial load bearing coupled to the input shaft and a second radial and axial load bearing coupled to the output shaft.

In any of the aspects or combinations of the aspects, the input shaft may be rotationally coupled to a prime mover.

In any of the aspects or combinations of the aspects, the prime mover may be an electric machine.

In any of the aspects or combinations of the aspects, the prime mover may be an internal combustion engine.

In any of the aspects or combinations of the aspects, the prime mover may be a traction motor in an electric vehicle.

In any of the aspects or combinations of the aspects, the gearbox system may further comprise an output shaft with a fourth helical gear coupled thereto; a fifth helical gear coupled to the first intermediate shaft; and a sixth helical gear coupled to the second intermediate shaft, wherein the fifth helical gear and the sixth helical gear are identically sized.

In any of the aspects or combinations of the aspects, the gearbox system may be included in an electric drive axle.

In any of the aspects or combinations of the aspects, the gearbox system may further comprise a fulcrum coupled to the balance beam. wherein the fulcrum is grounded by a stationary gearbox component.

In any of the aspects or combinations of the aspects, the stationary gearbox component may be a gearbox housing.

In any of the aspects or combinations of the aspects, the balance beam may be configured to axial translate and rotate.

Note that the example control and estimation routines included herein can be used with various powertrain, gearbox, and/or vehicle system configurations. The control methods and routines disclosed herein may be stored as executable instructions in non-transitory memory and may be carried out by the control system including the controller in combination with the various sensors, actuators, and other vehicle hardware. Further, the described actions, operations and/or functions may graphically represent code to be programmed into non-transitory memory of the computer readable storage medium in the vehicle control, where the described actions are carried out by executing the instructions in a system including the various hardware components in combination with the electronic controller. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, these specific examples are not to be considered in a limiting sense, because numerous variations are possible. For example, the above technology can be applied to powertrains that include different types of propulsion sources including different types of electric machines and engines (e.g., internal combustion engines). The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A gearbox system, comprising:
an input shaft with a first helical gear coupled thereto;
a first intermediate shaft with a second helical gear coupled thereto and meshing with the first helical gear;
a second intermediate shaft with a third helical gear coupled thereto and meshing with the first helical gear; and
a balance beam configured to transfer loads between the first intermediate shaft and the second intermediate shaft;
wherein the second helical gear and the third helical gear are identically sized.

2. The gearbox system of claim 1, further comprising:
a first axial thrust bearing coupled to a first end of the balance beam and the first intermediate shaft; and
a second axial thrust bearing coupled to a second end of the balance beam and the second intermediate shaft.

3. The gearbox system of claim 2, further comprising a fulcrum coupled to the balance beam.

4. The gearbox system of claim 3, wherein the fulcrum is grounded by a gearbox housing.

5. The gearbox system of claim 2, wherein the first end of the balance beam is coupled to the first axial thrust bearing via a first slotted interface and the second end of the balance beam is coupled to the second axial thrust bearing via a second slotted interface.

6. The gearbox system of claim 1, further comprising a first radial bearing coupled to the first intermediate shaft and a second radial bearing coupled to the second intermediate shaft.

7. The gearbox system of claim 1, further comprising:
an output shaft with a fourth helical gear coupled thereto;
a fifth helical gear coupled to the first intermediate shaft; and
a sixth helical gear coupled to the second intermediate shaft;
wherein the fifth helical gear and the sixth helical gear are identical in size.

8. The gearbox system of claim 7, further comprising a first radial and axial load bearing coupled to the input shaft and a second radial and axial load bearing coupled to the output shaft.

9. The gearbox system of claim 1, wherein the input shaft is rotationally coupled to a prime mover.

10. The gearbox system of claim 9, wherein the prime mover is an electric machine.

11. The gearbox system of claim 9, wherein the prime mover is an internal combustion engine.

12. A method for operation of a gearbox system, comprising:
balancing loads between a first intermediate shaft and a second intermediate shaft via a balance beam coupled to the first intermediate shaft and the second intermediate shaft via a first axial thrust bearing and a second axial thrust bearing;
wherein the gearbox system includes:
an input shaft with a first helical gear coupled thereto;
a second helical gear coupled to the first intermediate shaft and meshing with the first helical gear; and
a third helical gear coupled to the second intermediate and meshing with the first helical gear.

13. The method of claim 12, further comprising transferring mechanical power from a prime mover to the input shaft.

14. The method of claim 13, wherein the prime mover is a traction motor in an electric vehicle (EV).

15. A gearbox system, comprising:
an input shaft with a first helical gear coupled thereto;
a first intermediate shaft with a second helical gear coupled thereto and meshing with the first helical gear;
a second intermediate shaft with a third helical gear coupled thereto and meshing with the first helical gear; and
a balance beam coupled to the first intermediate shaft and the second intermediate shaft via a first axial thrust bearing and a second axial thrust bearing;
wherein the second helical gear and the third helical gear are identically sized; and wherein the first intermediate shaft and the second intermediate shaft are parallel to one another.

16. The gearbox system of claim 15, further comprising:
an output shaft with a fourth helical gear coupled thereto;
a fifth helical gear coupled to the first intermediate shaft; and
a sixth helical gear coupled to the second intermediate shaft, wherein the fifth helical gear and the sixth helical gear are identically sized.

17. The gearbox system of claim 15, wherein the gearbox system is included in an electric drive axle.

18. The gearbox system of claim 15, further comprising a fulcrum coupled to the balance beam. wherein the fulcrum is grounded by a stationary gearbox component.

19. The gearbox system of claim 18, wherein the stationary gearbox component is a gearbox housing.

20. The gearbox system of claim 15, wherein the balance beam is configured to axial translate and rotate.
